(19) United States
(12) Patent Application Publication
(10) Pub. No.: US 2020/0065856 A1
(43) Pub. Date: Feb. 27, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Shinji ICHIKAWA, Nagoya-shi (JP); Harunobu SAITO, Nagoya-shi (JP); Daiki KANEICHI, Nisshin-shi (JP); Ryotaro FUJIWARA, Tokyo-to (JP); Megumi AMANO, Toyota-shi (JP); Masato ENDO, Nagakute-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 16/550,622

(22) Filed: Aug. 26, 2019

(30) Foreign Application Priority Data
Aug. 24, 2018 (JP) 2018-157670

(51) Int. Cl. G06Q 30/02

(52) U.S. Cl. CPC G06Q 30/0254; G06Q 30/0266

(57) ABSTRACT

An information processing apparatus comprises a controller configured to execute displaying an advertisement; specification of a moving body that moves at a place at which the advertisement to be displayed can be viewed; storing attribute information of the specified moving body; performing statistical processing for the stored attribute information of the moving body; and determining the advertisement to be displayed on the basis of a result of the statistical processing.

### CROSS REFERENCE TO THE RELATED APPLICATION

This application claims the benefit of Japanese Patent Application No. 2018-157670, filed on Aug. 24, 2018, which is hereby incorporated by reference herein in its entirety.

### BACKGROUND

### Technical Field

The present disclosure relates to an information processing apparatus, an information processing method, and a non-transitory storage medium.

### Description of the Related Art

In recent years, such techniques have been disclosed that advertisements are not merely displayed, for example, on signboards, wherein the techniques relate to the improvement in the convenience of viewers who view the advertisements and/or the techniques relate to the effective advertisement delivery to viewers who view the advertisements. In Patent Literature 1, a navigation apparatus is disclosed, in which the convenience relevant to the guidance of a signboard is improved by storing signboard data in relation to the signboard while being correlated with facility data. Further, in Patent Literature 2, a system is disclosed, in which the number of viewers of an advertisement is counted by means of simpler configuration and the advertisement can be delivered effectively by utilizing the method for counting the number of viewers.

### PRIOR ART LITERATURE

### Patent Literature

Patent Literature 1: Japanese Patent Application Laid-Open No. 2007-240198

Patent Literature 2: Japanese Patent Application Laid-Open No. 2013-178820

### SUMMARY

An object of the present discloser is to provide a technique which enhances the power of an advertisement to appeal to consumers.

A first aspect of the present disclosure may reside in an information processing apparatus comprising a controller configured to execute:

displaying an advertisement;

specifying a moving body that moves at a place at which the advertisement to be displayed can be viewed;

storing attribute information of the specified moving body;

performing statistical processing for the stored attribute information of the moving body; and

determining the advertisement to be displayed on the basis of a result of the statistical processing.

A second aspect of the present disclosure may reside in an information processing apparatus comprising a controller configured to execute:

distinguishing a gesture performed by a viewer who has viewed the advertisement in a traveling vehicle as a predetermined gesture or distinguishing a voice uttered by the viewer as having a predetermined voice pattern;

photographing a scene including the advertisement viewed by the viewer if it is distinguished that the gesture performed by the view is the predetermined gesture or if it is distinguished that the voice uttered by the viewer has the predetermined voice pattern; and

storing image information of an image in which the photographed scene including the advertisement is imaged and the traveling history information of the vehicle.

A third aspect of the present disclosure may reside in an information processing method comprising:

displaying an advertisement;

specifying a moving body that moves at a place at which the advertisement to be displayed can be viewed;

storing attribute information of the specified moving body;

performing statistical processing for the stored attribute information of the moving body; and

determining the advertisement to be displayed on the basis of a result of the statistical processing.

A fourth aspect of the present disclosure may reside in a non-transitory storage medium storing a program for allowing a computer to execute:

displaying an advertisement;

specifying a moving body that moves at a place at which the advertisement to be displayed can be viewed;

storing attribute information of the specified moving body;

performing statistical processing for the stored attribute information of the moving body; and

determining the advertisement to be displayed on the basis of a result of the statistical processing.

According to the present disclosure, it is possible to provide the technique which enhances the power of the advertisement to appeal to consumers.

### BRIEF DESCRIPTION OF THE DRAWINGS

FIG. 1 shows an exemplary outline of configuration of an advertisement delivery system according to a first embodiment.

FIG. 2 shows an exemplary outline of a vehicle interior installed with an advertisement storage apparatus and a drive recorder.

FIG. 3 shows an exemplary outline of functional configuration of the advertisement saving apparatus.

FIG. 4 shows an exemplary outline of a table included in photographed image information DB.

FIG. 5 shows an exemplary outline of functional configuration of the drive recorder.

FIG. 6 shows an exemplary outline of functional configuration of a data center.

FIG. 7 shows an exemplary outline of a table included in photographed advertisement information DB.

FIG. 8 shows an exemplary outline of a table included in vehicle information DB.

FIG. 9 shows an exemplary outline of signage information DB.

FIG. 10 shows an exemplary outline of advertisement information DB.

FIG. 11 shows an exemplary outline of functional configuration of a delivery management server.

FIG. 12 shows an exemplary outline of functional configuration of a digital signage.

FIG. 13 shows an exemplary outline of functional configuration of an information terminal.

FIG. 14 shows an exemplary flow chart of a process in which the advertisement saving apparatus executes transmission of a control signal for photographing the advertisement to a photographing device.

FIG. 15 shows an exemplary flow chart of a process in which the advertisement saving apparatus executes a process for receiving a photographed image and transmitting the photographed image to an external apparatus.

FIG. 16 shows an exemplary flow in which the advertisement saving apparatus displays information stored in the photographed image information DB.

FIG. 17 shows an exemplary flow chart in which the drive recorder executes a photographing process.

FIG. 18 shows an exemplary flow chart for executing a process in which the advertisement information displayed try the data center is transmitted to the external apparatus.

FIG. 19 shows an exemplary flow chart for executing a process when the data center is requested for advertisement practice place information by the external apparatus.

FIG. 20 shows an exemplary flow chart for executing a process when the data center is requested for information relevant to the photographed image by the external apparatus.

FIG. 21 shows an exemplary flow chart in which the delivery management server executes an advertisement delivery process.

FIG. 22 shows an exemplary flow chart in which the digital signage executes a process for displaying the advertisement.

FIG. 23 shows an exemplary flow chart in which the information terminal executes a process for displaying the photographed image.

FIG. 24 shows an exemplary operation of the advertisement delivery system.

FIG. 25 shows an exemplary situation in which a driver is interested in an advertisement imaged on the digital signage installed aside a road during the traveling by a vehicle.

FIG. 26 shows an exemplary operation of the advertisement delivery system.

FIG. 27 shows an exemplary operation of the advertisement delivery system.

FIG. 28 shows an exemplary outline in which the received photographed image and the advertisement additional information are displayed on the information terminal.

FIG. 29 shows an exemplary outline of configuration of an advertisement display system according to a second embodiment.

FIG. 30 shows an exemplary outline of functional configuration of a delivery management server.

FIG. 31 shows an exemplary outline of moving body attribute information DB.

FIG. 32 shows an exemplary outline of functional configuration of a digital signage.

FIG. 33 shows an exemplary flow chart of a process in which the delivery management server executes the delivery of an advertisement.

FIG. 34 shows an exemplary flow chart for executing a process when a data center receives a request signal for requesting information relevant to the advertisement.

FIG. 35 shows an exemplary flow chart which the digital signage executes a photographing process.

FIG. 36 shows an exemplary flow chart in which the digital signage executes an advertisement display process.

FIG. 37 shows an exemplary operation of the advertisement display system.

FIG. 38 shows an exemplary situation of the photographing operation performed by the digital signage.

FIG. 39 shows an exemplary graph to depict a result which the attribute is subjected to the statistical processing for every time zone.

FIG. 40 shows exemplary display position information if the advertisement is displayed.

### DESCRIPTION OF THE EMBODIMENTS

For example, in order to enhance the power of the advertisement to appeal to customers, it is conceived that a display apparatus for displaying the advertisement, which is represented, for example, by a digital signage, is installed at a place such as a station, a bustling street and the like at which the traffic volume of people and/or vehicles is large. However, if the content of the advertisement displayed on the display apparatus is dissociated from the interest of a viewer of the advertisement who passes in front of the display apparatus, it is feared that the power of the advertisement to appeal to customers may be reduced.

Taking the foregoing situation into consideration, the information processing apparatus according to an embodiment of the present disclosure specifies a moving body that moves at a place at which an advertisement can be viewed to perform the statistical processing for attribute information of the moving body. Then, the advertisement to be displayed is determined on the basis of a result of the statistical processing.

In this context, the moving body includes a vehicle that moves at a place at which an advertisement to be displayed can be viewed, a driver who drives a moving vehicle, a fellow passenger, a person who walks at a place at which the advertisement can be viewed, and a person who moves while riding on a bicycle at a place at which the advertisement can be viewed.

If the moving body is a person, the attribute information of the moving body includes the appearance including, for example, the height, the clothes, the distinction of sex (sexuality), and the age. Further, if the moving body is a vehicle, the attribute information of the moving body includes the type of vehicle. Further, if the moving body is a vehicle, the attribute information of the moving body includes the information relevant to an owner of the vehicle (height, clothes, distinction of sex (sexuality), age, and family structure).

The information processing apparatus as described above makes it possible to perform the statistical processing for the attribute of the moving body which moves at the place at which the advertisement to be displayed can be viewed. Then, if any tendency is found in the attribute distribution of the moving body as a result of the statistical processing, the information processing apparatus described above can display the advertisement which conforms to the tendency of the attribute distribution. Therefore, the information processing apparatus described above can enhance the power of the advertisement to appeal to customers.

### First Embodiment

### (System Configuration)

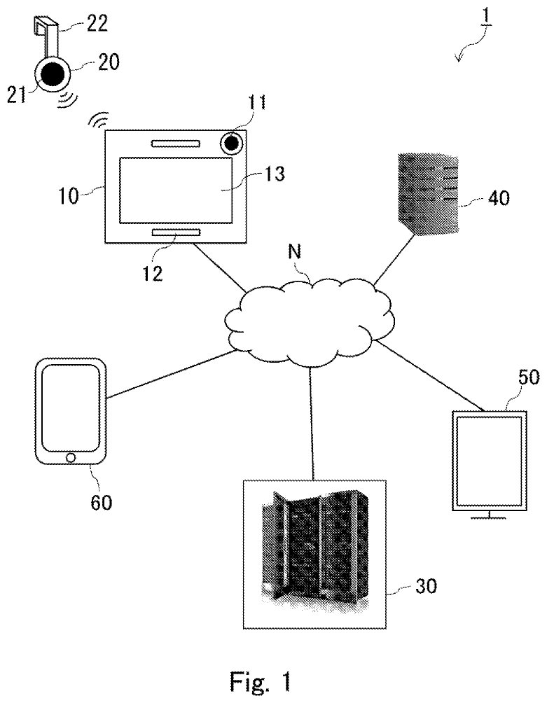

FIG. 1 shows an exemplary outline of configuration of an advertisement delivery system according to a first embodiment. The advertisement delivery system 1 according to this embodiment is formed by an advertisement saving apparatus 10, a drive recorder 20, a data center 30, a delivery management server 40, a digital signage 50, and an information terminal 60. In this context, the advertisement saving apparatus 10 is an example of the “information processing apparatus” of the present disclosure.

As shown in FIG. 1, the advertisement saving apparatus 10 is provided with a camera module 11. Further, the advertisement saving apparatus 10 has a microphone provided at the inside, and the advertisement saving apparatus 10 is provided with a hole 12 which is connected to the microphone. Further, the advertisement saving apparatus 10 is provided with a touch panel display 13.

Further, as shown in FIG. 1, the drive recorder 20 is provided with a camera module 21. Further, the drive recorder 20 is provided with a fixing member 22 for fixing the camera module 21 to a rearview mirror of a vehicle.

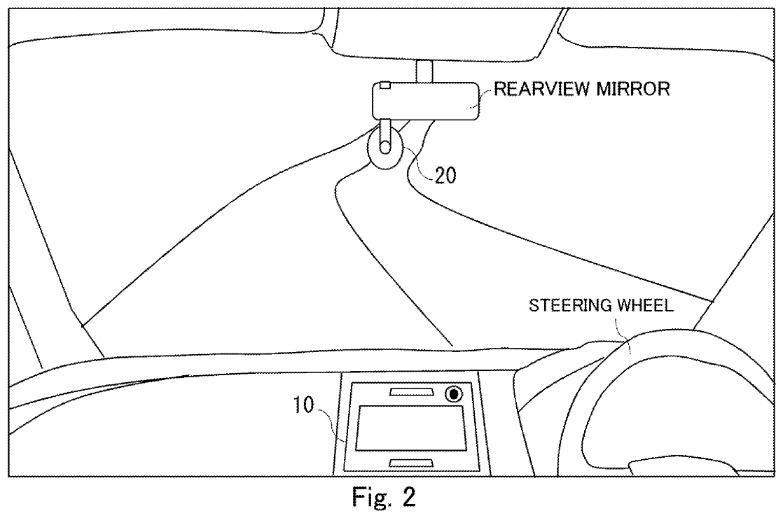

FIG. 2 shows an exemplary outline of the vehicle interior installed with the advertisement storage apparatus 10 and the drive recorder 20.

Even when a driver, who drives the vehicle to travel, notices an advertisement installed outside the vehicle when the driver allows the vehicle to travel and the driver is interested in the advertisement, then the driver cannot photograph and save the advertisement by operating a smartphone or the like by himself/herself. The advertisement saving apparatus 10 is installed for the situation as described above. If a predetermined gesture is performed and/or a predetermined voice is uttered, then the apparatus sends a signal of a photographing command to the drive recorder 20 so that the advertisement can be photographed.

Therefore, the advertisement saving apparatus 10 is provided, for example, in the vicinity of a dashboard in front of a driver's seat of the vehicle in an oblique direction. Then, the advertisement saving apparatus 10 detects the gesture performed by a driver or a fellow passenger and/or the voice uttered by the driver or the fellow passenger. The place, at which the advertisement saving apparatus 10 is installed, is not limited to the place exemplified in FIG. 2 by way of example. However, it is preferable that the direction of the lens of the camera module 11 and/or the hole 12 connected to the microphone is/are directed to the driver and/or the fellow passenger.

Further, advertisement storage apparatus 10 can receive an image in which the photographed advertisement is imaged, from the drive recorder 20, and the advertisement saving apparatus 10 can save the image as well.

The drive recorder 20 is fixed, for example, to the rearview mirror of the vehicle. Further, as described above, the drive recorder 20 is such an apparatus that the scene outside the vehicle can be photographed if the signal of the photographing command is received from the advertisement storage apparatus.

The data center 30 is an apparatus which various pieces of information are accumulated. The various pieces information include, for example, photographed images in which advertisements are photographed from the vehicle interior by the driver, information relevant to the advertisements imaged in the photographed images, vehicle information, and place information of places at which the digital signages 50 are installed.

The delivery management server 40 manages the delivery information to be delivered to the digital signage 50. The delivery information includes, for example, the advertisement age and the time for displaying the advertisement.

The digital signage 50 is an apparatus which displays the advertisement formed by screen images and letters or characters. The digital signage 50 may be installed at a place at which the traffic volume of people and vehicles is large, including, for example, the station yard, the wall surface of the building in the bustling street, and the area along the main road.

The information terminal 60 accesses the data center 30 to acquire the image having been photographed during the driving of the vehicle. Then, the terminal is capable of displaying the acquired image. It is not necessarily indispensable that the information terminal 60 should be installed at the inside of the vehicle. The information terminal 60 may be a mobile or portable terminal. That is, even when the driver gets off the vehicle, the driver can see the photographed image by the aid of the information terminal 60.

In the advertisement delivery system 1 according to this embodiment, the advertisement saving apparatus 10, the data center 30, the delivery management server 40, the digital signage 50, and the information terminal 60 are connected to one another by means of a network (N). For the network, for example, it is also allowable to adopt WAN (Wide Area Network) which is the worldwide public communication network such as the internet or the like, as well as other communication networks. Further, the network may include the telephone communication network for the mobile phone or the like and the wireless communication network such as Wi-Fi (registered trademark) or the like. Further, in the advertisement delivery system 1 according to this embodiment, the advertisement saving apparatus 10 and the drive recorder 20 are connected to one another by means of, for example, Wi-Fi or Bluetooth (registered trademark).

### (Functional Configuration)

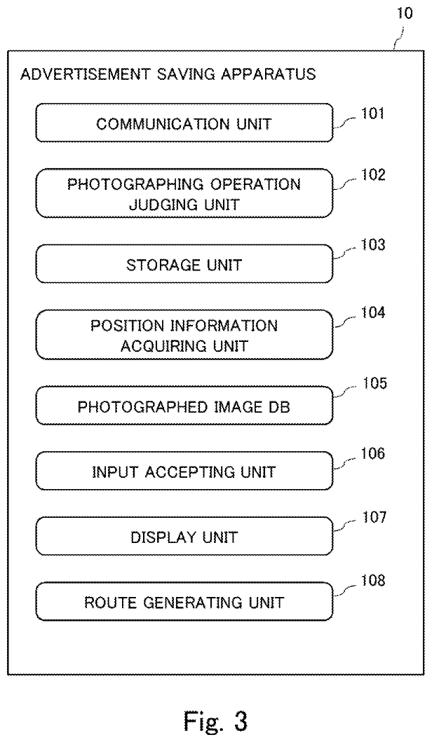

FIG. 3 shows an exemplary outline of functional configuration of the advertisement saving apparatus 10. The advertisement saving apparatus 10 is a computer which has a processor such as CPU and the like, a main storage device such as RAM, ROM and the like, EPROM, an auxiliary storage device such as a hard disk drive, removable media and the like, the camera module 11, and the microphone. Further, the advertisement saving apparatus 10 is provided with a display device and an input device including, for example, a touch panel display 13. Further, the advertisement saving apparatus 10 is provided with a GPS module. Further, the removable media may be, for example, a USB memory or a disk recording medium such as CD and DVD. For example, an operating system (OS), various programs, and various tables are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The advertisement saving apparatus 10 is provided with a communication unit 101. The communication unit 101 is a wireless communication interface for connecting the advertisement saving apparatus 10 to the network. The communication unit 101 provides the access to the network, for example, by means of any mobile communication service including, for example, wireless LAN, 3G, LTE and the like.

Further, the advertisement saving apparatus 10 is provided with a photographing operation judging unit 102. The photographing operation judging unit 102 detects a signal inputted from the camera module 11 or a signal inputted firm the microphone. Further, the photographing operation judging unit 102 judges whether or not the photographing operation is executed on the basis of the input signal. Further, if the photographing operation judging unit 102 judges that the photographing operation is to be executed, then the photographing operation judging unit 102 generates a control signal for the photographing operation, and the photographing operation judging unit 102 transmits the control signal to the drive recorder 20 by the aid of the communication unit 101. The control signal for the photographing operation may include information in relation to the photographing direction and the number of times of the photographing operation or operations.

Further, the advertisement saving apparatus 10 is provided with a storage unit 103. The storage unit 103 is configured to include the main storage device and the auxiliary storage device. The main storage device is a memory for developing the program executed by the processor and the data utilized by the control program. The auxiliary storage device is a device for storing the program executed by the processor and the data utilized by the control program. The auxiliary storage device may store the operating system for executing the program. The function as described above is realized by loading the program stored in the auxiliary storage device to the main storage device and executing the program by the processor.

Further, the advertisement saving apparatus 10 is provided with a position information acquiring unit 104. The position information acquiring unit 104 is the means for acquiring the position information of the advertisement saving apparatus 10, i.e., the position information of the vehicle on which the advertisement saving apparatus 10 is installed. The position information acquiring unit 104 acquires the position information of the advertisement saving apparatus 10 (for example, latitude and longitude), for example, from the GPS module. Further, the acquired position information is stored by the storage unit 103.

Further, the advertisement saving apparatus 10 includes a photographed image information database (DB) 105 for storing therein the information relevant to the photographed image to be stored. The photographed image information DB 105 is constructed such that the program of the database management system, which is executed by the processor, manages the data stored in the storage unit 103. The photographed image information DB 105 is, for example, a relational database.

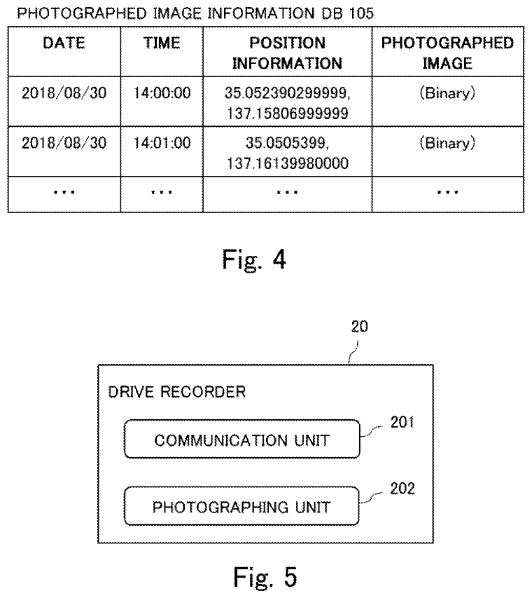

FIG. 4 shows an exemplary outline of a table included in the photographed image information DB 105. As shown in FIG. 4, the photographed image information DB stores “date” on which the image was photographed, “time” at which the image was photographed, “position information” of the vehicle, and “photographed image data”. Further, in the following description, the date on which the image was photographed, the time at which the image was photographed, and the position information of the vehicle are referred to as “traveling history information”.

Further, the advertisement saving apparatus 10 is provided with an input accepting unit 106. The input accepting unit 106 accepts the input from the user by the aid of the touch panel display 13.

Further, the advertisement saving apparatus 10 is provided with a display unit 107. The display unit 107 displays the information on the touch panel display 13, for example, on the basis of the input operation of the user accepted by the input accepting unit 106.

Further, the advertisement saving apparatus 10 is provided with a route generating unit 108. The route generating unit 108 generates the route from the present point to the destination by using the position information of the present point, the position information of the destination, and known route generating means.

Further, the processor possessed by the advertisement saving apparatus 10, which executes the program to realize the functions as described above, is an example of the “controller” of the present disclosure.

Next, an explanation will be made about functional configuration of the drive recorder 20. FIG. 5 shows an exemplary outline of functional configuration of the drive recorder 20. The drive recorder 20 is an apparatus which has a processor such as CPU and the like, a main storage device such as RAM, ROM and the like, EPROM, an auxiliary storage device such as a hard disk drive, removable media and the like, and the camera module 21. Note that the removable media may be, for example, a USB memory or a disk recording medium such as CD and DVD. For example, an operating system (OS), various programs, and various tables are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The drive recorder 20 is provided with a communication unit 201. The communication unit 201 is a wireless communication interface for connecting the drive recorder 20 to the advertisement saving apparatus 10. The wireless communication between the drive recorder 20 and the advertisement saving apparatus 10 is realized, for example, by means of Wi-Fi or Bluetooth.

Further, the drive recorder 20 is provided with a photographing unit 202. The photographing unit 202 controls the photographing operation performed by the camera module 21. The photographing unit 202 can also control the photographing direction and the number of times of the photographing operation or operations in accordance with a control signal.

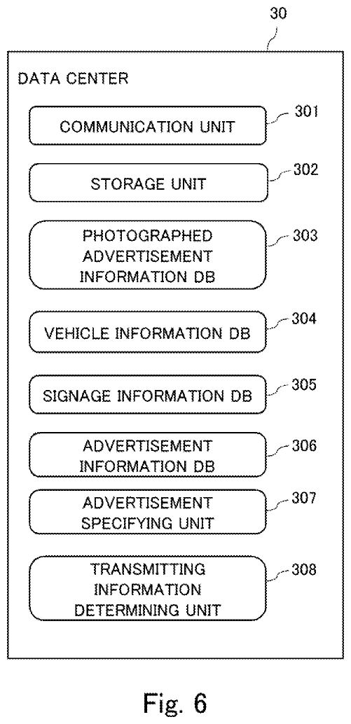

Next, an explanation will be made about functional configuration of the data center 30. FIG. 6 shows an exemplary outline of functional configuration of the data center 30. The data center 30 is a computer which has a processor such as CPU, GPU and the like, a main storage device such as RAM, ROM and the like, EPROM, and an auxiliary storage device such as a hard disk drive, removable media and the like. Note that the removable media may be, for example, a USB memory or a disk recording medium such as CD and DVD. For example, an operating system (OS), various programs, and various tables are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The data center 30 is provided with a communication unit 301. The communication unit 301 is a wireless communication interface for connecting the data center 30 to the network. The communication unit 301 provides the access to the network, for example, by means of any mobile communication service including, for example, wireless LAN, 3G, LTE and the like.

Further, the data center 30 is provided with a storage unit 302. The storage unit 302 is configured to include the main storage device and the auxiliary storage device. The main storage device is a memory for developing the program executed by the processor and the data utilized by the control program. The auxiliary storage device is a device for storing the program executed by the processor and the data utilized by the control program. The auxiliary storage device may store the operating system for executing the program. The function as described above is realized by loading the program stored in the auxiliary storage device to the main storage device and executing the program by the processor.

Further, the data center 30 includes photographed advertisement information DB 303 in which the information relevant to the photographed image is stored. Further, the data center 30 includes vehicle information DB 304 in which the information relevant to the vehicle is stored. Further, the data center 30 includes signage information DB 305 in which the information relevant to the digital signage 50 is stored. Further, the data center 30 includes advertisement information DB 306 in which the information relevant to the advertisement to be displayed is stored. The photographed advertisement information DB 303, the vehicle information DB 304, the signage information DB 305, and the advertisement information DB 306 are constructed such that the program of the database management system, which is executed by the processor, manages the data stored in the storage unit 302. The photographed advertisement information DB 303, the vehicle information DB 304, the signage information DB 305, and the advertisement information DB 306 are, for example, relational databases.

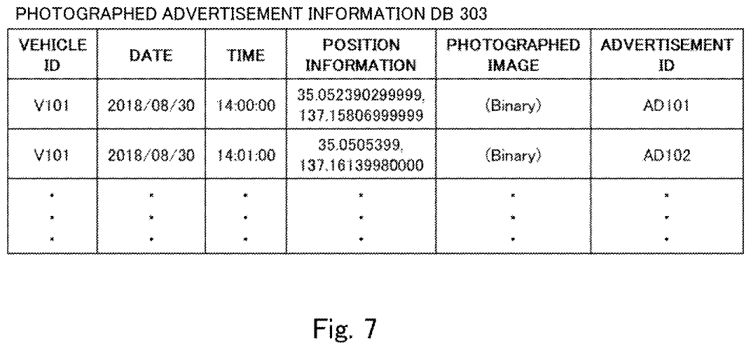

FIG. 7 shows an exemplary outline of a table included in the photographed advertisement information DB 303. The photographed advertisement information DB stores “vehicle ID” (Identification) for distinguishing the vehicle in which the photographing operation for photographing the image was executed, “date” on which the image was photographed, “time” at which the image was photographed, “position information” of the vehicle, “photographed image data”, and “advertisement ID” for distinguishing the advertisement imaged in the photographed image. However, the information stored in the photographed advertisement information DB 303 may be appropriated updated.

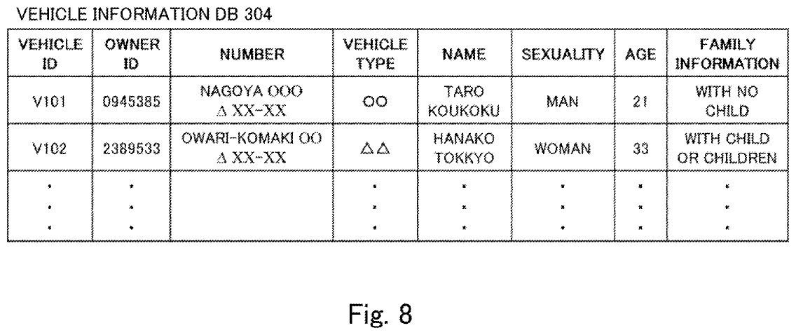

FIG. 8 shows an exemplary outline of a table included in the vehicle information DB 304. The vehicle information DB 304 stores “vehicle ID” for distinguishing the vehicle, “owner ID” for distinguishing the owner of the vehicle, “vehicle number”, “vehicle type”, “name of owner”, “sexuality of owner”, “age of owner”, and “family information of owner” including presence or absence of child or children. However, the information stored in the vehicle information DB 304 may be appropriately updated.

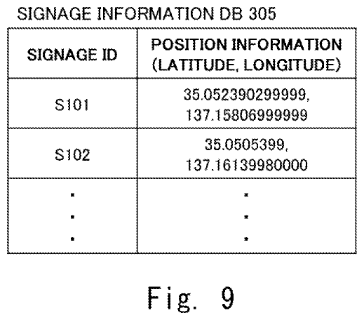

FIG. 9 shots an exemplary outline of the signage information DB 305. The signage information DB 305 stores “signage ID” for distinguishing the signage and “position information (latitude, longitude)” of the place at which the signage is installed. However, the information stored in the signage information DB 305 nay be appropriately updated.

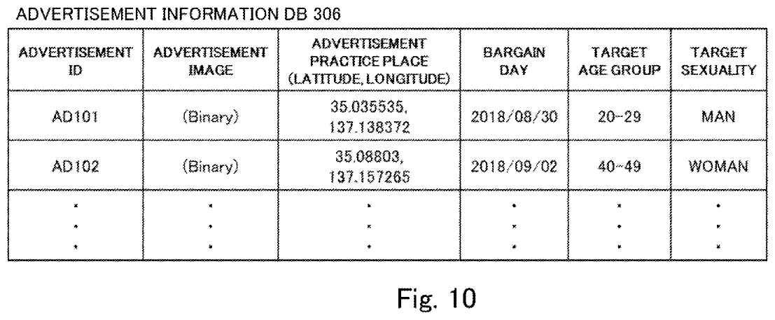

FIG. 10 shows an exemplary outline of the advertisement information DB 306. The advertisement information DB 306 previously stores “advertisement ID” for distinguishing the advertisement, “advertisement image information”, “place information” of the place at which the advertisement is practiced, and “advertisement additional information”. Further, the advertisement additional information includes, for example, “bargain day” of the advertised merchandise and “target information” (for example, “age group” and “sexuality”) of the target intended by the advertiser. Further, the advertisement image may include information relevant to the advertiser. Further, the information stored in the advertisement information DB 306 may be appropriately updated.

Further, the data center 30 is provided with an advertisement specifying unit 307. The advertisement specifying unit 307 distinguishes the advertisement imaged in the image from the image information, and the advertisement specifying unit 307 specifies the advertisement. Any known image recognition technique may be used for the distinguishing method.

Further, the data center 30 is provided with a transmitting information determining unit 308. If a request is given to the data center 30 to transmit the information, the transmitting information determining unit 308 extracts the data stored in the photographed advertisement information DB 303, the vehicle information DB 304, the signage information DB 305, and the advertisement information DB 306. Then, the information to be given to the request source is determined on the basis of the extracted information.

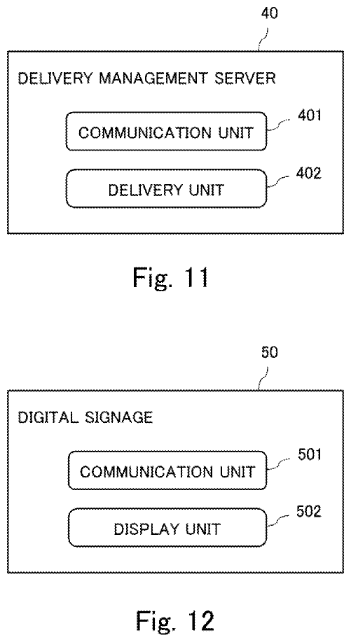

Next, an explanation will be made about functional configuration of the delivery management server 40. FIG. 11 shows an exemplary outline of functional configuration of the delivery management server 40. The delivery management server 40 is a computer which has a processor such as CPU and the like, a main storage device such as RAM, ROM and the like, EPROM, and an auxiliary storage device such as a hard disk drive, removable media and the like. Note that the removable media may be, for example, a USB memory or a disk recording medium such as CD and DVD. For example, an operating system (OS), various programs, and various tables are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The delivery management server 40 is provided with a communication unit 401. The communication unit 401 is a wireless communication interface for connecting the delivery management server 40 to the network. The communication unit 401 provides access to the network, for example, by means of any mobile communication service including, for example, wireless LAN, 3G, LTE and the like.

Further, the delivery management server 40 is provided with a delivery unit 402. The delivery unit 402 delivers the advertisement to the digital signage 50. The information to be delivered includes, for example, the advertisement image, the display time for displaying the advertisement, and the number of times of display of the advertisement.

Next, an explanation will be made about functional configuration of the digital signage 50. FIG. 12 shows an exemplary outline of functional configuration of the digital signage 50. The digital signage 50 is an apparatus which has a processor such as CPU and the like, a main storage device such as RAM, ROM and the like, EPROM, a hard disk drive, and a display apparatus. The display apparatus is formed, for example, by a liquid crystal display, an organic EL display, an LED matrix, or a projector. For example, an operating system (OS) and various programs are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The digital signage 50 is provided with a communication unit 501. The communication unit 501 is a wireless communication interface for connecting the digital signage 50 to the network. The communication unit 501 provides the access to the network, for example, by means of any mobile communication service including, for example, wireless LAN, 3G, LTE and the like.

Further, the digital signage 50 is provided with a display unit 502. The display unit 502 displays the image information received by the communication unit on the display apparatus. Further, if the communication unit receives the information relevant to the display (for example, the display time and the number of times of display), the image information is displayed on the display apparatus in accordance with the information.

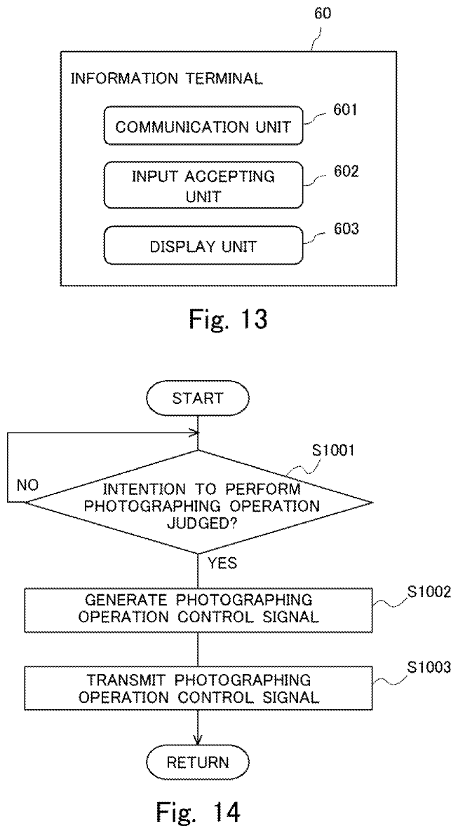

Next, an explanation will be made about functional configuration of the information terminal 60. FIG. 13 shows an exemplary outline of functional configuration of the information terminal 60. The information terminal 60 is a computer which has a processor such as CPU and the like, a main storage device such as RAM, ROM and the like, EPROM, an auxiliary storage device such as a hard disk drive, removable media and the like, an input device, and a display device. The information terminal 60 is, for example, a smartphone having a touch panel display. Note that the removable media my be, for example, a USB memory or a disk recording medium such as CD and DVD. For example, an operating system (OS), various programs, and various tables are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The information terminal 60 is provided with a communication unit 601. The communication unit 601 is a wireless communication interface for connecting the information terminal 60 to the network. The communication unit 601 provides the access to the network, for example, by means of any mobile communication service including, for example, wireless LAN, 3G, LTE and the like.

Further, the information terminal 60 is provided with an input accepting unit 602. The input accepting unit 602 accepts the input from the user by the aid of the touch panel display.

Further, the information terminal 60 is provided with a display unit 603. The display unit 603 displays the information on the touch panel display, for example, on the basis of the input operation of the user accepted by the input accepting unit 602.

### (Process Flows of Respective Apparatuses)

Next, an explanation will be made about process flows executed by the respective apparatuses. FIG. 14 shows an exemplary flow chart of a process in which the advertisement saving apparatus 10 executes transmission of a control signal for photographing the advertisement to the photographing device.

### (S1001)

In Step S1001, the intention of the driver to perform the photographing operation is judged. If any gesture is performed by the driver, the photographing operation judging unit 102 receives the input signal relevant to the gesture by the aid of the camera module 11 of the advertisement saving apparatus 10. Further, if any voice is uttered by the driver, the photographing operation judging unit 102 receives the input signal relevant to the voice by the aid of the microphone of the advertisement saving apparatus 10. Then, the photographing operation judging unit 102 judges the intention of the driver to perform the photographing operation on the basis of the input signal. The judgment of the intention to perform the photographing operation is performed, for example, in accordance with a pattern recognition algorithm. Further, the advertisement saving apparatus 10 may be provided with a button for the photographing operation. Then, the photographing operation judging unit 102 way make the judgment of the intention to perform the photographing operation by receiving an input signal generated by depressing the button for the photographing operation.

### (S1002)

In Step S1002, if the photographing operation judging unit 102 judges that the driver desires to perform the photographing operation, the photographing operation judging unit 102 generates a control signal for the photographing operation. The gesture, by which it is judged that the driver desires to perform the photographing operation, may be, for example, a gesture in which the forefinger points to something. Further, the voice pattern, by which it is judged that the driver desires to perform the photographing operation, may be, for example, a pattern which corresponds to a voice of “photograph the scene in front”.

### (S1003)

In Step S1003 the communication unit 101 transmits the control signal for the photographing operation to the photographing device.

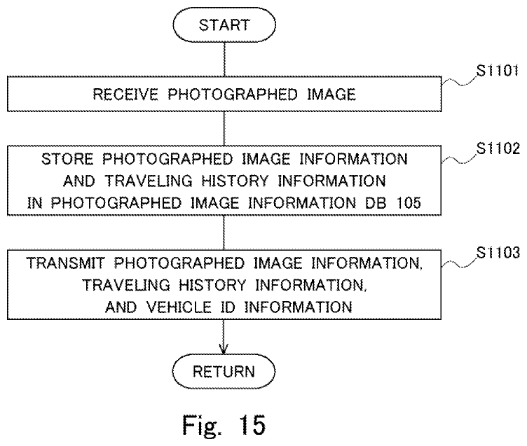

Further, FIG. 15 shows an exemplary flow chart of a process in which the advertisement saving apparatus 10 executes a process for receiving a photographed image and transmitting the photographed image to the external apparatus.

### (S1101)

In Step S1101, the communication unit 101 receives the photographed image information from the photographing device.

### (S1102)

In Step S1102, the storage unit 103 stores the received photographed image information in the photographed image information DB 105. Further, the storage unit 103 stores the traveling history information such as the current date, the current time, and the position information of the vehicle in the same record as that of the photographed image information, in addition to the photographed image information. In this procedure, the position information of the vehicle is acquired by the position information acquiring unit 104.

### (S1103)

In Step S1103, the communication unit 101 transmits the information stored in the photographed image information DB 105 to the external apparatus. Further, the communication unit 101 transmits the information while adding the vehicle ID information thereto as well.

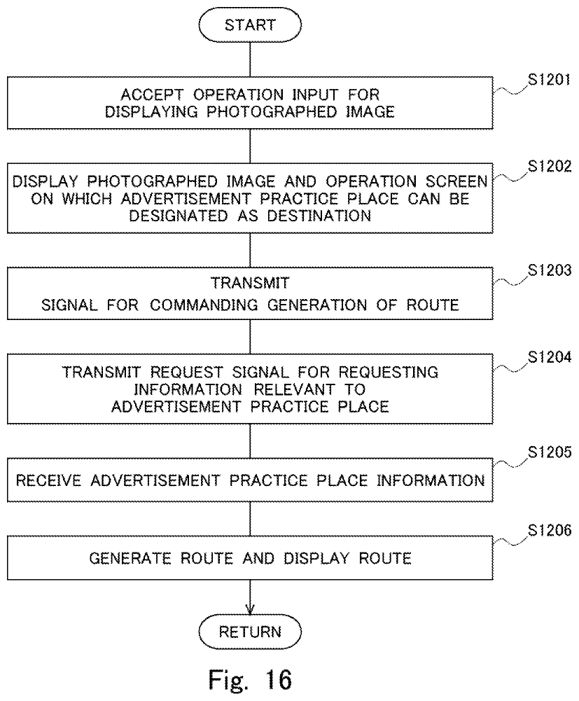

Further, FIG. 16 shows an exemplary flow in which the advertisement saving apparatus 10 displays the information stored in the photographed image information DB 105.

### (S1201)

In Step S1201, the input accepting unit 106 accepts the operation input for displaying photographed image.

### (S1202)

In Step S1202, the display unit 107 displays the photographed image stored in the photographed image information DB 105 on the basis of the accepted input. Further, the display unit 107 displays the operation screen on which the practice place of the advertisement imaged in the displayed photographed image can be designated as the destination of the vehicle, together with the photographed image.

### (S1203)

In Step S1203, if the input accepting unit 106 accepts the input in which the practice place of the advertisement is the destination, a signal is transmitted to the route generating unit 108 to command the generation of the route.

### (S1204)

In Step S1204, if the signal to command the generation of the route is accepted, the route generating unit 108 transmits a request signal for requesting the information relevant to the advertisement practice place to the apparatus in which the information relevant to the practice place of the advertisement is stored, by the aid of the communication unit 101. In this case, the request signal includes the vehicle ID information, the traveling history information, and the photographed image information stored in the photographed image information DB 105.

### (S1205)

In Step S1205, the route generating unit 108 receives a response signal relevant to the advertisement practice place from the apparatus in which the information relevant to the practice place of the advertisement is stored, by the aid of the communication unit 101. Further, the position information acquiring unit 104 acquires the present position of the vehicle, and the position information is sent to the route generating unit 108.

### (S1206)

In Step S1206, the route generating unit 108 generates the route on the basis of the acquired position information of the vehicle and the information relevant to the advertisement practice place. Then, the display unit 107 displays the generated route.

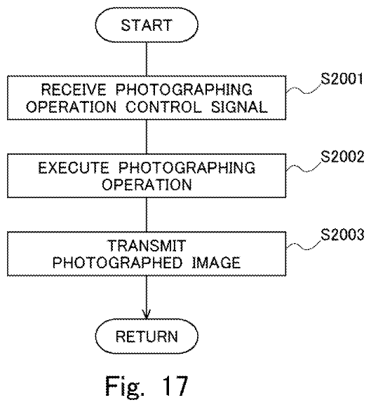

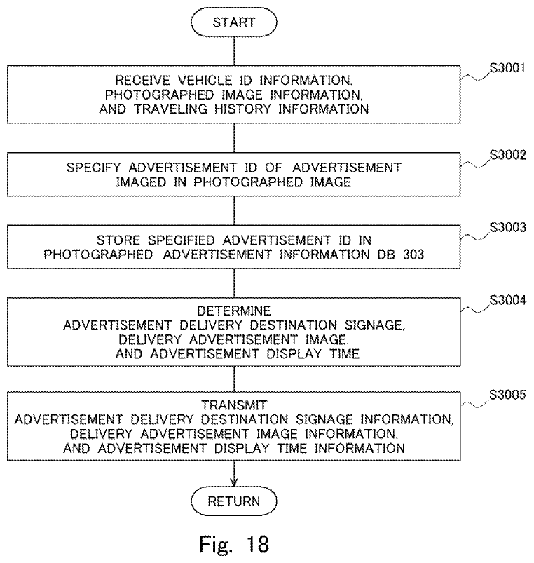

In the next place, FIG. 17 shows an exemplary flow chart in which the drive recorder 20 executes the photographing process.

### (S2001)

In Step S2001, the communication unit 201 receives a control signal for the photographing operation.

### (S2002)

In Step S2002, the photographing unit 202 executes the photographing operation on the basis of the received control signal.

### (S2003)

In Step S2003, the communication unit 201 transmits the image information of the photographed image to the transmission source of the control signal.

In the next place, FIG. 13 shows an exemplary flow chart for executing a process in which the data center 30 accumulates the information, and the advertisement information, which is displayed on the basis of the accumulated information, is transmitted to the external apparatus.

### (S3001)

In Step S3001, the communication unit 301 receives the vehicle ID information, the traveling history information, and the photographed image information from the external apparatus. Then, the storage unit 302 stores the received vehicle ID information, the traveling history information, and the photographed image information in the photographed advertisement information DB 303.

### (S3002)

In Step S3002, the advertisement specifying unit 307 specifies the advertisement ID of the advertisement imaged in the photographed image stored in the photographed advertisement information DB 303. The advertisement specifying unit 307 firstly distinguishes the advertisement image imaged in the photographed image by using the image recognition technique. Then, the advertisement specifying unit 307 extracts the same advertisement image as the distinguished advertisement image from the data stored in the advertisement information DB 306. When the extraction is performed, the image recognition technique is also used. Then, the advertisement ID, which corresponds to the extracted advertisement image, is extracted from the data stored in the advertisement information DB 306. In this procedure, any image recognition technique may be used.

### (S3003)

In Step S3003, the storage unit 302 stores the extracted advertisement ID in the same record as the record included in the photographed advertisement information DB 303 for storing therein the photographed image in which the concerning advertisement is imaged.

### (S3004)

In Step S3004, the transmitting information determining unit 308 performs a process in order that the information relevant to the advertisement imaged in the photographed image is displayed on the digital signage 50 which is installed at the point along which the vehicle that has photographed the image is predicted to pass in future. At first, the point, along which the vehicle will pass future, is predicted from the traveling history stored in the photographed advertisement information DB 303. Any method is available as the predicting method. Then, the transmitting information determining unit 308 obtains the digital signage 50 installed at a place near to the predicted point along which the vehicle will pass, on the basis of the position information of the digital signage 50 stored in the signage information DB 305. Then, the transmitting information determining unit 308 determines the concerning digital signage 50 as the advertisement delivery destination signage. In this procedure, any number of advertisement delivery destination signage or signages is/are available.

Further, the transmitting information determining unit 308 extracts the advertisement image information of the advertisement imaged in the photographed image photographed by the vehicle for which the passing point is predicted, from the advertisement information DB 306. When the information is extracted, the advertisement ID stored in the photographed advertisement information DB 303 is used. Then, the transmitting information determining unit 308 determines the advertisement image information as the delivery image information. Further, the transmitting information determining unit 308 also determines the time for which the advertisement is to be displayed on the advertisement delivery destination signage.

### (S3005)

In Step S3005, the c cation unit 301 transmits, to the external apparatus, the signage ID of the digital signage determined as the advertisement delivery destination signage by the transmitting information determining unit 308, the delivery image information, and the time information of the time for which the advertisement image is to be displayed on the advertisement delivery destination signage.

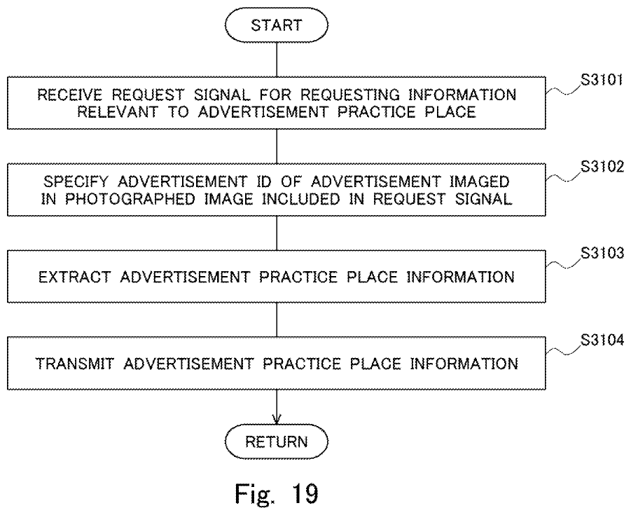

In the next place, FIG. 19 shows an exemplary flow chart for executing a process when the data center 30 is requested for advertisement practice place information by the external apparatus.

### (S3101)

In Step S3101, the communication unit 301 receives the request signal for requesting the advertisement practice place information from the external apparatus. In this procedure, the request signal includes the vehicle ID information, the traveling history information, and the photographed image information.

### (S3102)

In Step S3102, the advertisement specifying unit 307 specifies the advertisement ID of the advertisement imaged in the received photographed image. The process for specifying the advertisement ID the same as or equivalent to the process for specifying the advertisement in Step S3002.

### (S3103)

In Step S3103, the transmitting information determining unit 308 extracts the advertise It practice place information corresponding to the specified advertisement ID from the data stored in the advertisement information DB 306. Then, the transmitting information determining unit 308 determines the transmission of the extracted advertisement practice place information to the transmission source of the request signal.

### (S3104)

In Step S3104, the communication unit 301 transmits, to the transmission source of the request signal, the advertisement practice place information which is determined to be transmitted by the transmitting information determining unit 308.

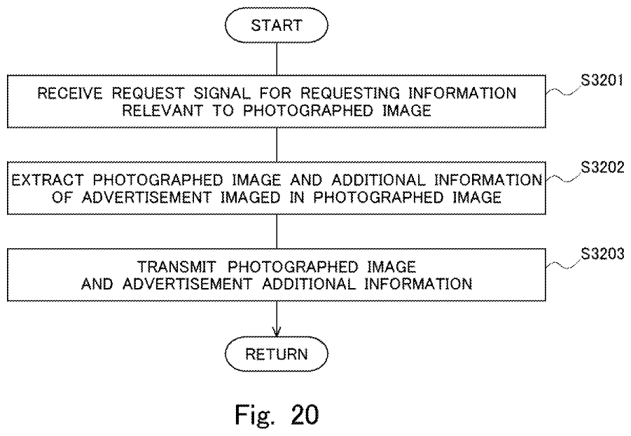

In the next place, FIG. 20 shows an exemplary flow chart for executing a process when the data center 30 is requested for the information relevant to the photographed image by the external apparatus.

### (S3201)

In Step S3201, the communication unit 301 receives the request signal for requesting the information relevant to the photographed image. The request signal includes the owner ID information of the owner of the vehicle.

### (S3202)

In Step S3202, the vehicle ID, which corresponds to the owner ID of the owner of the vehicle, is extracted from the information stored in the vehicle information DB 304 on the basis of the owner ID information of the owner of the vehicle received by the transmitting information determining unit 308.

Then, the transmitting information determining unit 308 extracts the photographed image information corresponding to the vehicle ID and the advertisement ID information of the advertisement imaged in the photographed image from the information stored in the photographed advertisement information DB 303 on the basis of the extracted vehicle ID information.

Then, the transmitting information determining unit 308 extracts the advertisement additional information corresponding to the advertisement ID information from the information stored in the advertisement information DB 306 on the basis of the extracted advertisement ID information. For example, if any merchandise appears in the advertisement, the advertisement additional information includes the bargain day information of the merchandise.

Then, the transmitting information determining unit 308 determines that the extracted photographed image information and the advertisement additional information are transmitted as the information relevant to the photographed image to the transmission source of the request signal.

### (S3203)

In Step S3203, the communication unit 301 transmits the photographed image and the advertisement additional information to the transmission source of the request signal.

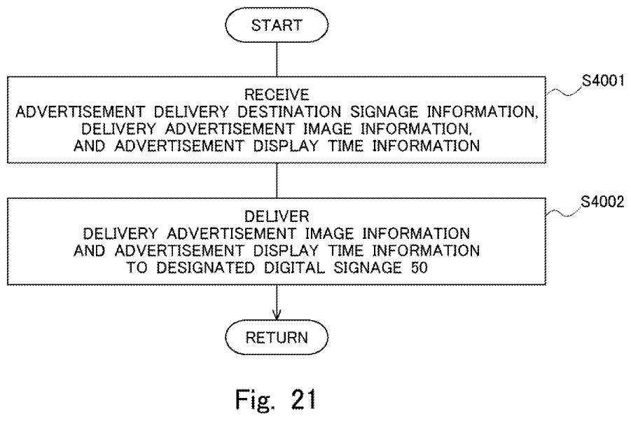

In the next place, FIG. 21 shows an exemplary flow chart in which the delivery management server 40 executes an advertisement delivery process.

### (S4001)

In Step S4001, the communication unit 401 receives the information relevant to the advertisement from the external apparatus. The information relevant to the advertisement includes the signage ID of the digital signage 50 as the delivery destination of the advertisement, the advertisement image information to be delivered, and the time information for displaying the advertisement image on the digital signage 50 at the delivery destination of the advertisement.

### (S4002)

In Step S4002, the delivery unit 402 delivers the advertisement image information to the digital signage 50 designated as the delivery destination of the advertisement. Further, the delivery unit 402 also delivers, to the digital signage 50, the information for displaying the advertisement image on the digital signage 50 designated as the delivery destination of the advertisement.

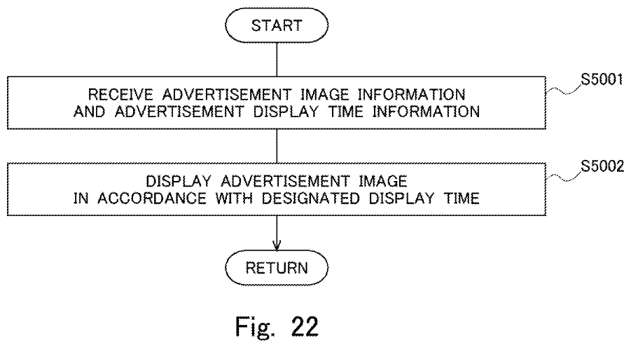

In the next place, FIG. 22 shows an exemplary flow chart in which the digital signage 50 executes a process for displaying the advertisement.

### (S5001)

In Step S5001, the communication unit 501 receives the advertisement image to be displayed and the display time information from the external apparatus.

### (S5002)

In Step S5002, the display unit 502 outputs the received advertisement image to the splay apparatus. Further, the time for outputting the advertisement image is determined in accordance with the received display time information.

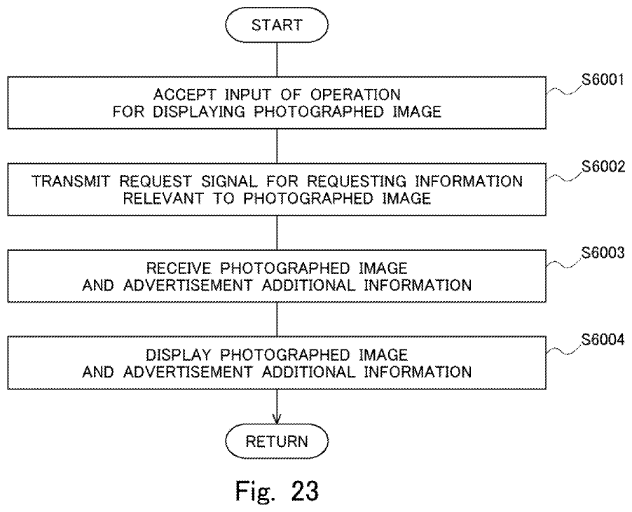

In the next place, FIG. 23 shows an exemplary flow chart in which the information terminal 60 executes a process for displaying the photographed image.

### (S6001)

In Step S6001, the input accepting unit 602 accepts the input of the operation for displaying the photographed image by the aid of the input device.

### (S6002)

In Step S6002, the communication unit 601 transmits the request signal for requesting the information relevant to the photographed image to the external apparatus. The request signal includes the owner ID information of the owner of the vehicle.

### (S6003)

In Step S6003, the communication unit 601 receives, from the transmission destination of the request signal, the photographed image information and the advertisement additional information added to the advertisement imaged in the photographed image. For example, if the advertisement relates to the merchandise, the advertisement additional information include the bargain day information of the merchandise.

### (S6004)

In Step S6004, the display unit 603 outputs, to the display device, the received photographed image and the advertisement additional information.

### (Exemplary Operation of Advertisement Delivery System 1)

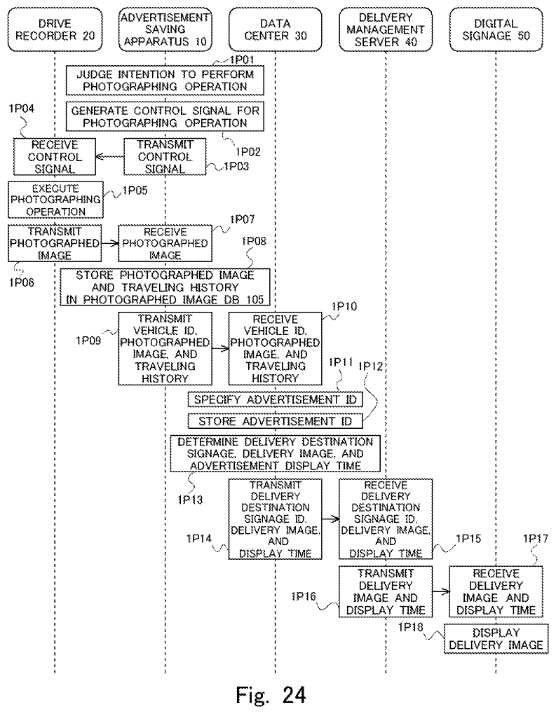

Next, an explanation will be made about an example of exemplary operation of the advertisement delivery system 1. FIG. 24 shows an exemplary operation of the advertisement delivery system 1 when such a process is executed that an advertisement, which is photographed during the driving by a driver of a vehicle, is displayed for the driver at a place distinct from a photographing place.

### (Pattern 1P01)

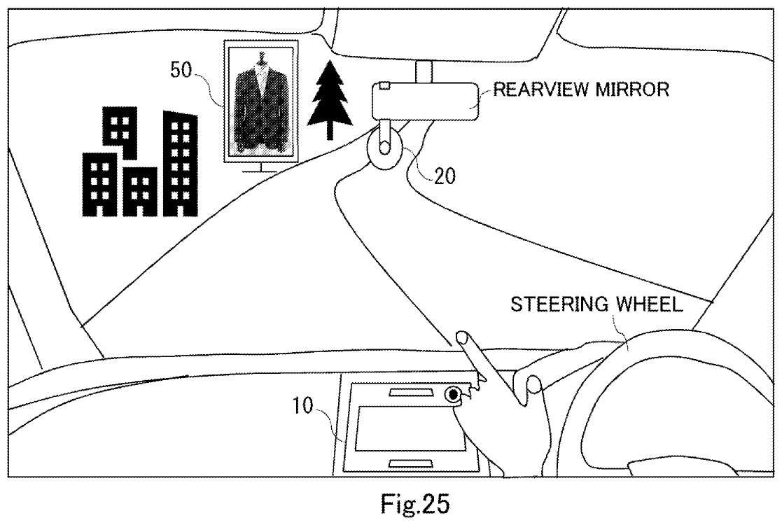

FIG. 25 shows an exemplary situation in which a driver is interested in an advertisement imaged on the digital signage 50 installed aside a road during the traveling by a vehicle. It is assumed that the driver is, for example, a young man having an age in twenties. Further, it is assumed that an advertisement image of a suit directed to young men is displayed on the digital signage 50.

The driver performs such a gesture that a forefinger is directed to the digital signage 50. Accordingly, the process of Step S1001 is executed, and it is judged whether or not the driver of the vehicle has the intention to perform the photographing operation. Alternatively, if the driver is interested in the advertisement imaged on the digital signage 50, the driver may utter a voice “photograph the scene in front”.

### (Pattern 1P02)

The process of Step S1002 is executed, and it is judged that the driver desires to perform the photographing operation. Then, the control signal for the photographing operation is generated.

### (Pattern 1P03)

The process of Step S1003 is executed, and the control signal for the photographing operation is transmitted to the drive recorder 20. In this procedure, the control signal may include the information relevant to the direction directed by the forefinger.

### (Pattern 1P04)

The process of Step S2001 is executed, and the drive recorder 20 receives the control signal for the photographing operation.

### (Pattern 1P05)

The process of Step S2002 is executed, and the drive recorder 20 executes the photographing operation on the basis of the control signal for the photographing operation received by the drive recorder 20. Further, if the information relevant to the direction directed by the forefinger is included in the control signal for the photographing operation, the drive recorder 20 executes the photographing operation while controlling the direction of the lens of the camera on the basis of the information of the direction.

### (Pattern 1P06)

The process of Step S2003 is executed, and the photographed image information is transmitted to the advertisement saving apparatus 10.

### (Pattern 1P07)

The process of Step S1101 is executed, and the advertisement saving apparatus 10 receives the photographed image information from the drive recorder 20.

### (Pattern 1P08)

The process of Step S1102 is executed, and the received photographed image information is stored, in the photographed image information DB 105. Further, the traveling history information, which includes, for example, the current date, the current time, and the position information of the vehicle, is stored in the same record as that of the photographed image information, in addition to the photographed image information.

### (Pattern 1P09)

The process of Step S1103 is executed, and the photographed image information and the traveling history information, which are stored in the photographed image information DB 105, are transmitted to the data center 30. Further, the information transmitted to the data center 30 also includes the vehicle ID information.

### (Pattern 1P10)

The process of Step S3001 is executed, and the data center 30 receives the photographed image information, the traveling history information, and the vehicle ID information from the advertisement saving apparatus 10. Then, the received photographed image information, the traveling history information, and the vehicle ID information are stored in the photographed advertisement information DB 303.

### (Pattern 1P11)

The process of Step S3002 is executed, and the advertisement ID of the advertisement imaged in the received photographed image is specified.

### (Pattern 1P12)

The process of Step S3003 is executed, and the specified advertisement ID is stored in the same record as the record included in the photographed advertisement information DB 303 in which the photographed image imaged with the advertisement is stored.

### (Pattern 1P13)

The process of Step S3004 is executed, and the point, along which the vehicle installed with the advertisement saving apparatus 10 that has transmitted the photographed image will pass in future, is predicted from the traveling history stored in the photographed advertisement information DB 303. Then, the digital signage 50, which is installed at a place near to the predicted passing point, is obtained on the basis of the position information of the digital signage 50 stored in the signage information DB 305. Then, the obtained digital signage 50 is determined as the advertisement delivery destination signage.

Further, the advertisement image information of the advertisement imaged in the photographed image is extracted from the advertisement information DB 306. Then, the extracted advertisement image information is determined as the delivery image information.

Further, the advertisement display time, for which the advertisement image is displayed on the advertisement delivery destination signage, is also determined. In this embodiment, the advertisement display time is determined so that the advertisement image is repeatedly displayed on the advertisement delivery destination signage. Further, a plurality of advertisement delivery destination signages are also available. Different advertisement play times may be set for respective signages of the delivery destinations depending on the positions of installation of the plurality of advertisement delivery destination signages.

### (Pattern 1P14)

The process of Step S3005 is executed, and the signage ID corresponding to the advertisement delivery destination signage the delivery image information, and the advertisement display time information for the delivery destination signage are transmitted to the delivery management server 40.

### (Pattern 1P15)

The process of Step S4001 is executed, and the delivery management server 40 receives the signage ID corresponding to the advertisement delivery destination signage, the delivery image information, and the advertisement display time information for the delivery destination signage from the data center 30.

### (Pattern 1P16)

The process of Step S4002 is executed, and the delivery image information as the advertisement image is transmitted to the digital signage 50 corresponding to the received signage ID. Further, the advertisement display time information for displaying the advertisement image is transmitted to the digital signage 50.

### (Pattern 1P17)

The process of Step S5001 is executed, and the digital signage 50 receives the delivery image information as the advertisement image from the delivery management server 40. Further, the digital signage 50 also receives the advertisement display time information from the delivery management server 40.

### (Pattern 1P18)

The process of Step S5002 is executed, and the delivered advertisement image is displayed on the digital signage 50 in accordance with the display time information. Further, if the information relevant to the advertiser is included in the advertisement image, the information relevant to the advertiser is also displayed. Further, in this embodiment, the advertisement image is repeatedly displayed. That is, the driver sees the advertisement of the suit displayed on the digital signage 50 again at any distinct place during the traveling by the vehicle.

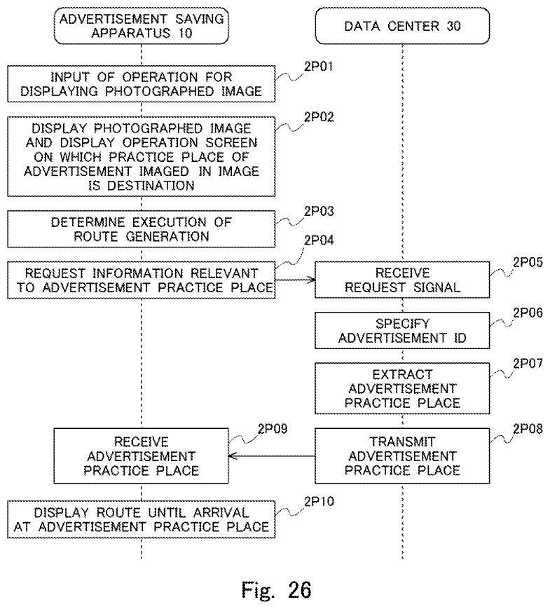

Further, FIG. 26 shows an exemplary operation of the advertisement delivery system 1 when a process is executed such that the photographed image, which is photographed during the traveling of the vehicle, is displayed toward the driver during the stop of the vehicle thereafter.

### (Pattern 2P01)

The process of Step S1201 is executed, and the advertisement saving apparatus 10 accepts the input of operation for displaying the photographed image.

### (Pattern 2P02)

The process of Step S1202 is executed, and the photographed image stored in the photographed image information DB 105 is displayed on the basis of the accepted input operation. Further, together with the photographed image, an operation screen, on which the practice place of the advertisement imaged in the photographed image can be the destination of the vehicle, is displayed together with the photographed image.

### (Pattern 2P03)

The process of Step S1203 is executed, and the advertisement saving apparatus 10 determines the execution of the generation of the route, if the advertisement saving apparatus 10 accepts the input in which the practice place of the advertisement is the destination.

### (Pattern 2P04)

The process of Step S1204 is executed, and a request signal for requesting the information relevant to the advertisement practice place is transmitted to the data center 30. In this procedure, the request signal includes the vehicle ID information, the traveling history information, and the photographed image information stored in the photographed image information DB 105.

### (Pattern 2P05)

The process of Step S3101 is executed, and the data center 30 receives the request signal for requesting the information relevant to the advertisement practice place. In this procedure, the request signal includes the vehicle ID information, the traveling history information, and the photographed image information.

### (Pattern 2P06)

The process of Step S3102 is executed, and the advertisement ID of the advertisement imaged in the received photographed image is specified.

### (Pattern 2P07)

The process of Step S3103 is executed, and the advertisement practice place information, which corresponds to the specified advertisement ID, is extracted from the advertisement information DB 306.

### (Pattern 2P08)

The process of Step S3104 is executed, and the extracted advertisement practice place information is transmitted to the advertisement saving apparatus 10.

### (Pattern 2P09)

The process of Step S1205 is executed, and the advertisement saving apparatus 10 receives the practice place information of the advertisement to be displayed from the data center 30.

### (Pattern 2P10)

The process of Step S1206 is executed, and the route from the present position of the vehicle to the practice place of the advertisement is generated on the basis of the position information of the vehicle and the received practice place information of the advertisement. Then, the generated route info is displayed on the display device.

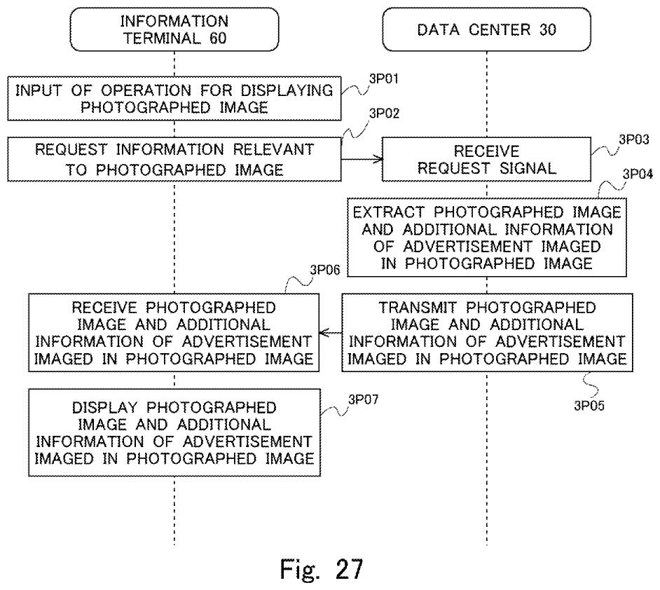

Further, FIG. 27 shows an exemplary operation of the advertisement delivery system 1 when a process is executed so that the driver can see the photographed image photographed during the traveling of the vehicle after the driver gets off the vehicle.

### (Pattern 3P01)

The process of Step S6001 is executed, and the information terminal 60 accepts the input of operation for displaying the photographed image.

### (Pattern 3P02)

The process of Step S6002 is executed, and a request signal for requesting the information relevant, to the photographed image is transmitted to the data center 30. In this procedure, the request signal includes the owner ID information of the owner of the vehicle.

### (Pattern 3P03)

The process of Step S3201 is executed, and the data center 30 receives the request signal for requesting the information relevant to the photographed image from the information terminal 60. In this procedure, the request signal include, the owner ID information of the owner of the vehicle.

### (Pattern 3P04)

The process of Step S3202 is executed, and the vehicle ID, which corresponds to the received owner ID information of the vehicle, is extracted from the vehicle information DB 304. Further, the photographed image which corresponds to the extracted vehicle ID information and the advertisement ID information of the advertisement which is imaged in the photographed image are extracted from the photographed advertisement information DB 303. Further, the advertisement additional information, which corresponds to the extracted advertisement ID information, is extracted from the advertisement information DB 306. The advertisement additional information includes, for example, the bargain day information of the suit displayed on the digital signage 50.

### (Pattern 3P05)

The process of Step S3203 is executed, and the data center 30 transmits the extracted photographed image information and the advertisement additional information to the information terminal 60.

### (Pattern 3P06)

The process of Step S6003 is executed, and the information terminal 60 receives the photographed image information and the advertisement additional information from the data center 30.

### (Pattern 3P07)

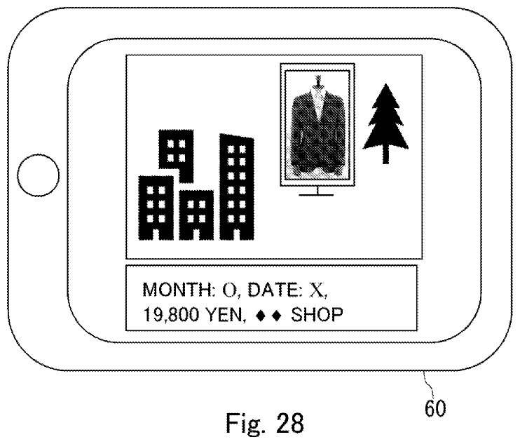

The process of Step S6004 is executed, and the received photographed image and the advertisement additional information are displayed. FIG. 28 shows an exemplary outline in which the received photographed image and the advertisement additional information are displayed on the information terminal 60. As shown in FIG. 28, the driver sees the photographed image and the bargain day information of the suit imaged in the photographed image, by the aid of the information terminal 60.

### (Effect of First Embodiment)

In the first embodiment, if the driver notices the advertisement displayed on the digital signage 50 during the traveling by the vehicle and the driver is interested in the advertisement, then the driver can photograph the advertisement by exhibiting the gesture or uttering the voice. Then, the advertisement, in which the driver is interested, is repeatedly displayed on the digital signages 50 installed at the distinct places along which it is predicted that the vehicle passes. Therefore, the driver sees the interested advertisement again at the distinct places. That is, the power of the advertisement to appeal to the customer is enhanced.

Further, the photographed image is stored in the advertisement saving apparatus 10 and the data center 30. That is, the driver can see the photographed image during the stop of the vehicle or after the driver gets off the vehicle. Further, the first embodiment, when the driver looks at the photographed image with the information terminal 60 again after the driver gets off the vehicle, the bargain day information of the advertisement imaged in the photographed image is displayed. That is, the advertisement delivery system as described above provides the effect to enhance the power of the advertisement imaged in the photographed image to appeal to the customer. Further, the driver can also look at the photographed image as a memory again.

Further, in the case of the advertisement delivery system 1 as described above, the route is displayed, in which the destination is the practice place of the advertisement imaged in the photographed image. That is, the advertisement delivery system 1 as described above is the apparatus having the excellent convenience which makes it possible for the driver to easily grasp the route until arrival at the advertisement practice place.

### (Modified Embodiment of First Embodiment)

In the first embodiment, the advertisement is photographed and the photographing operation data is saved by the advertisement saving apparatus 10 and the drive recorder 20. However, for example, the advertisement saving apparatus 10 and the drive recorder 20 may be substituted with the information terminal 60. However, the information terminal 60 is provided with two cameras, i.e., a camera for photographing the gesture of the driver and a camera for photographing the landscape outside the vehicle. Further, the information terminal 60 may be fixed, for example, to the dashboard of the vehicle.

Further, the advertisement saving apparatus 10 of the first embodiment may be a portable apparatus which can be carried. Further, respective DB's included in the data center 30 may be periodically uploaded to the advertisement saving apparatus 10. Further, if the advertisement saving apparatus 10 is provided with respective DB's included in the data center 30, the processes performed by the data center 30 may be executed the advertisement saving apparatus 10.

### Second Embodiment

### (System Configuration)

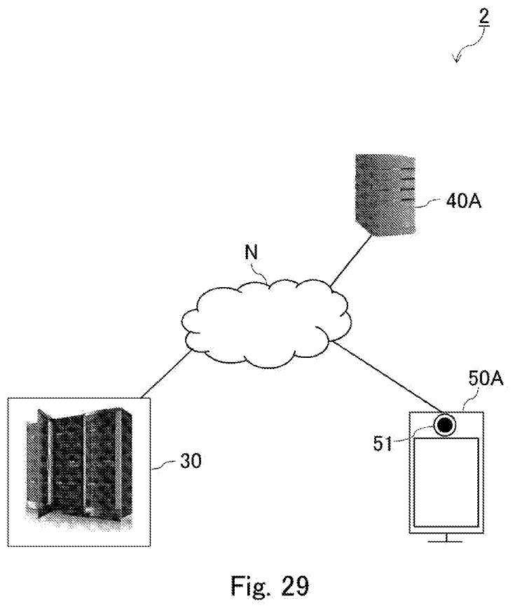

FIG. 29 shows an exemplary outline of configuration of an advertisement display system according to a second embodiment. The advertisement display system 2 according to this embodiment is formed by a data center 30, a delivery management server 40A, and a digital signage 50A. Further, the digital signage 50A has a camera module 51 provided at an upper portion.

### (Functional Configuration)

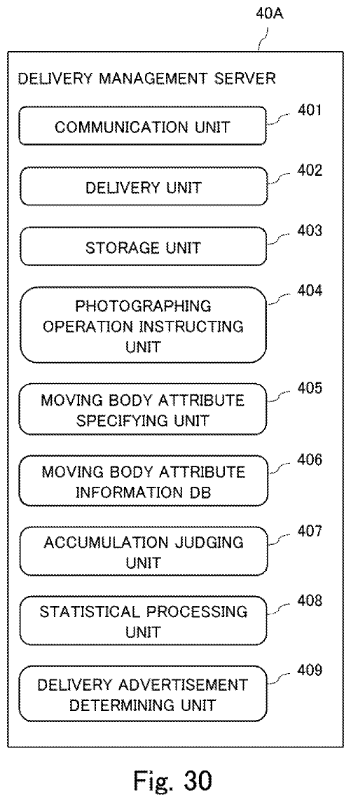

FIG. 30 shows an exemplary outline of functional configuration of the delivery management server 40A. The delivery management server 40A includes the same apparatus configuration and the same functions as those of the delivery management server 40 according to the first embodiment.

Further, the delivery management server 40A is provided with a storage unit 403 in addition to the functions of the delivery management server 40. The storage unit 403 is configured to include a main storage device and an auxiliary storage device. The main storage device is a memory for developing the program executed by the processor and the data utilized by the control program. The auxiliary storage device is a device for storing the program executed by the processor and the data utilized by the control program. The auxiliary storage device nay store the operating system for executing the program. The function as described above is realized by loading the program stored in the auxiliary storage device to the main storage device and executing the program by the processor.

Further, the delivery management server 40A is provided with a photographing operation instructing unit 404. The photographing operation instructing unit 404 generates a control signal for the photographing operation with respect to the digital signage 50A as described later on.

Further, the delivery management server 40A is provided with a moving body attribute specifying unit 405. The moving body attribute specifying unit 405 distinguishes the object imaged in the image to specify the attribute of the moving body. An image recognition technique is used to specify the attribute of the moving body. Any image recognition technique is usable.

Further, the delivery management server 40A includes moving body attribute information DB 406. The moving body attribute information DB 406 is constructed such that the program of the database management system, which is executed by the processor, manages the data stored in the storage unit 403. The moving body attribute information DB 406 is, for example, a relational database.

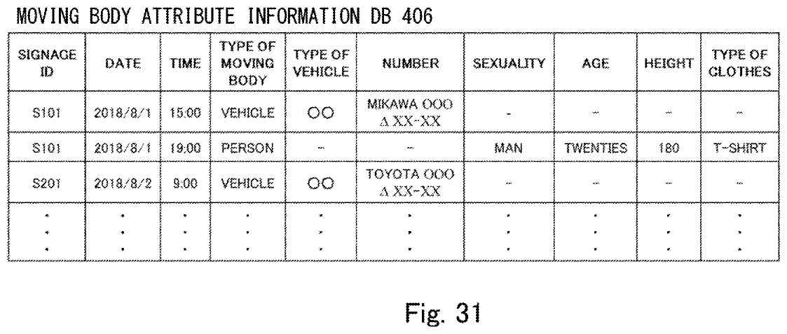

FIG. 31 shows an exemplary outline of the moving body attribute information DB 406. The moving body attribute information. DB 406 stores the information in relation to “signage ID” for distinguishing the signage, “date” on which the image as photographed, “time” at which the image was photographed, “type of moving body”, “type of vehicle”, “number of vehicle”, “sexuality” of moving body, “age” of moving body”, “height” of moving body, and “type of clothes” put on by moving body.

Further, the delivery management server 40A is provided with an accumulation judging unit 407. The accumulation judging unit 407 judges whether or not a desired amount of data is accumulated in the moving body attribute information DB 406.

Further, the delivery management server 40A is provided with a statistical processing unit 408. The statistical processing unit 408 extracts the attribute information stored in the moving body attribute information DB 406 to execute the statistical processing.

Further, the delivery management server 40A is provided with a delivery advertisement determining unit 409. The delivery advertisement determining unit 409 determines the advertisement image to be delivered to the digital signage 50A on the basis of a result of the statistical processing performed by the statistical processing unit 408. In this procedure, any technique, which includes, for example, any known machine learning technique and any empirical technique, is available as the technique for determining the optimum advertisement information on the basis of the result of the statistical processing. Further, the delivery advertisement determining unit 409 also determines the advertisement display time for displaying the advertisement on the advertisement delivery destination signage on the basis of the result of the statistical processing performed by the statistical processing unit 408.

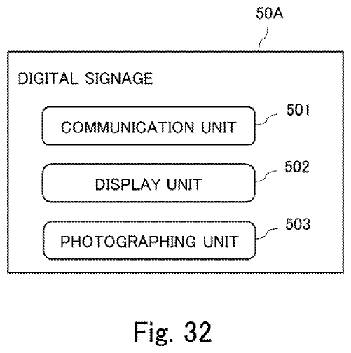

Further, FIG. 32 shows an exemplary outline of functional configuration of the digital signage 50A. The digital signage 50A is provided with a photographing unit 503 in addition to the functions provided for the digital signage 50. The photographing unit 503 controls the photographing operation performed by the camera module 51. The photographing unit 503 can also control, for example, the photographing direction and the number of times of photographing operation or photographing operations. Further, the digital signage 50A may be provided with LED (Light Emitting Diode) to emit light with the LED light when the photographing operation is performed in the night.

Further, the processor, which is possessed by the delivery management server 40A for executing the programs to realize the functions as described above, is an example of the “controller” of the present disclosure.

### (Process Flows of Respective Apparatuses)

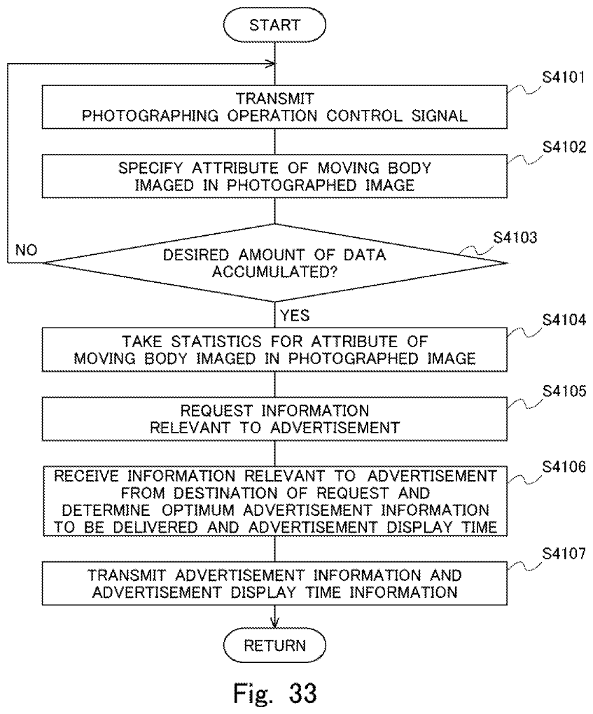

Next, an explanation will be made about process flows executed by the respective apparatuses. FIG. 33 shows an exemplary flow chart of a process in which the delivery management server 40A executes the delivery of an advertisement.

### (S4101)

In Step S4101, the photographing operation instructing unit 404 generates a control signal for the photographing operation. The control signal for the photographing operation may include the information of, for example, the time of photographing operation, the frequency of the photographing operation, and the angle of the photographing operation. Then, the transmitting unit 401 transmits the generated control signal for the photographing operation to the photographing device.

### (S4102)

In Step S4102, the communication unit 401 receives the photographed image and the information of photographing operation time from the photographing device. Then, the moving body attribute specifying unit 405 distinguishes the moving body imaged in the received photographed image to specify the attribute of the moving body. If the moving body is a vehicle, the attribute of the moving body is, for example, the type of vehicle and the number. On the other band, if the moving body is a person, the attribute of the moving body is, for example, the sexuality, the age, the height, and the type of clothes put thereon. Then, the storage unit 403 stores the attribute information of the specified attribute of the moving body, the information of the photographing device with which the photographing operation was executed, the information of date on which the photographing operation was performed, and the information of the time at which the photographing operation was performed, to the moving body attribute information DB.

### (S4103)

In Step S4103, the accumulation judging unit 407 judges whether or not a desired amount of data is accumulated in the moving body attribute information DB 406.

### (S4104)

In Step S4104, if it is judged by the accumulation judging unit 407 that the desired amount of data is accumulated in the roving body attribute information DB 406, the statistical processing unit 408 extracts the data stored in the moving body attribute information DB 406. Then, the statistical processing unit 408 executes a process for taking statistics for the attribute of the extracted data. On the other hand, if it is not judged by the accumulation judging unit 407 that the desired amount of data is accumulated in the moving body attribute information DB 406, the routine returns to Step S4101.

### (S4105)

In Step S4105, the delivery advertisement determining unit 409 requests the transmission of the information relevant to the advertisement to the external apparatus by the aid of the communication unit 401.

### (S4106)

In Step S4106, the communication unit 401 receives the information relevant to the advertisement from the destination of request for which the information relevant to the advertisement is to be requested. Further, the delivery advertisement determining unit 409 determines the optimum advertisement information to be delivered to the apparatus for displaying the advertisement on the basis of the result of the statistical processing performed by the statistical processing unit 408 and the information relevant to the advertisement. Further, the delivery advertisement determining unit 409 also determines the optimum advertisement display time for displaying the advertisement on the basis of the result of the statistical processing performed by the statistical processing unit 408 and the information relevant to the advertisement.

### (S4107)

In Step S4107, the transmitting unit 401 transmits, to the advertisement display apparatus, the advertisement information determined to be delivered by the delivery advertisement determining unit 409 and the information relevant to the advertisement display time. In this procedure, the advertisement information includes the advertisement image.

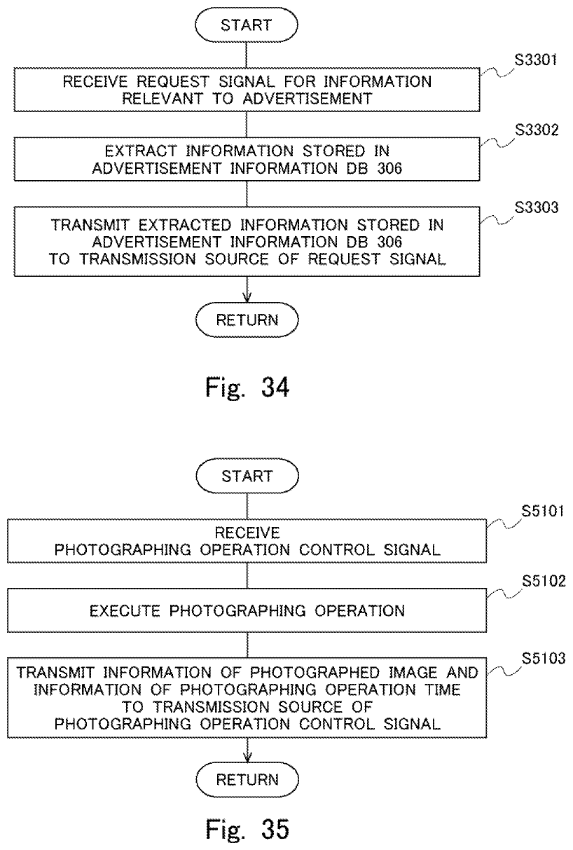

In the next place, FIG. 34 shows an exemplary flow chart for executing a process when the data center 30 receives a request signal for requesting information relevant to the advertisement.

### (S3301)

In Step S3301, the communication unit 301 receives the request signal for requesting the information relevant to the advertisement from the external apparatus.

### (S3302)

In Step S3302, the transmission information determining unit 308 extracts the information stored in the advertisement information DB 306.

### (S3303)

In Step S3303, the communication unit 301 transmits the extracted information stored in the advertisement information DB 306 to the transmission source of the request signal.

In the next place, FIG. 35 shows an exemplary flow chart in which the digital signage 50A executes a photographing process.

### (S5101)

In Step S5101, the communication unit 501 receives a control signal for the photographing operation from the external apparatus.

### (S5102)

In Step S5102, the photographing unit 503 executes the photographing operation in accordance with the control signal for the photographing operation received by the photographing unit 503.

### (S5103)

In Step S5103, the communication unit 501 transmits the information of the photographed image and the information of the photographing operation time to the transmission source of the control signal for the photographing operation.

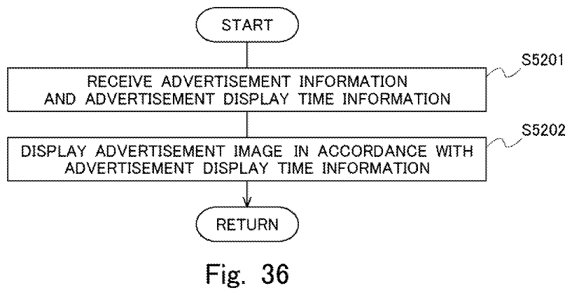

In the next place, FIG. 36 shows an exemplary flow chart in which the digital signage 50A executes an advertisement display process.

### (S5201)

In Step S5201, the communication unit 501 receives the advertisement information and the information relevant to the advertisement display time from the external apparatus. In this procedure, the advertisement information includes the advertisement image.

### (S5202)

In Step S5202, the display unit displays the received advertisement image. Further, the display time of the advertisement image follows the received advertisement display time information.

### (Exemplary Operation of Advertisement Display System 2)

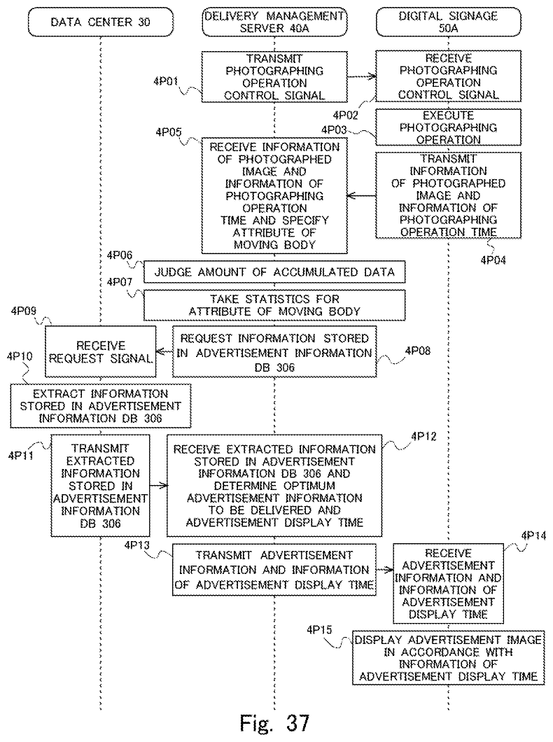

Next, an explanation will be made about an exemplary operation of the advertisement display system 2 by way of example. FIG. 37 shows an exemplary operation of the advertisement display system 2 when a process is executed for displaying an optimum advertisement for the moving body which passes in front of the digital signage 50A.

### (Pattern 4P01)

The process of Step S4101 is executed, and the delivery management server 40A generates the control signal for the photographing operation performed by the digital signage 50A. Then, the generated control signal for the photographing operation is transmitted to the digital signage 50A. Further, one digital signage 50A or a plurality of digital signages 50A is/are available as the transmission destination or transmission destinations of the photographing operation control signal.

### (Pattern 4P02)

The process of Step S5101 is executed, and the digital signage 50A receives the control signal for the photographing operation from the delivery management server 40A.

### (Pattern 4P03)

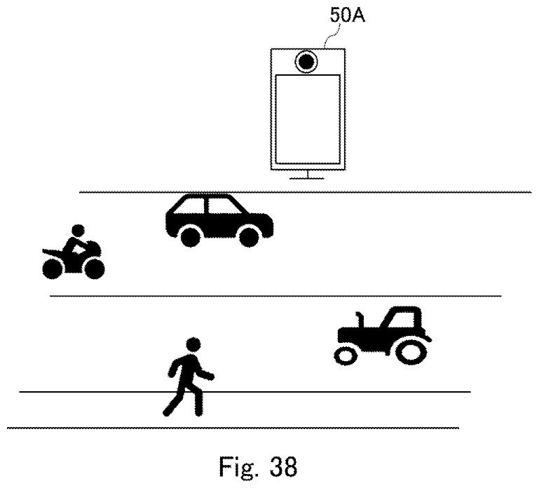

The process of Step S5102 is executed, and the digital signage 50A photographs the landscape in the vicinity of the digital signage 50A on the basis of the received control signal for the photographing operation. FIG. 38 shows an exemplary situation of the photographing operation performed by the digital signage 50A. The digital signage 50A photographs the landscape including moving bodies such as vehicles, persons, motorcycles, and bicycles passing in front of the digital signage 50A

### (Pattern 4P04)

The process of Step S5103 is executed, and the information of the photographed image and the information of the photographing operation time are transmitted to the delivery management server 40A.

### (Pattern 4P05)

The process of Step S4102 is executed, and the delivery management server 40A receives the photographed image information and the photographing operation time information from the digital signage 50A. Then, the moving body imaged in the photographed image is distinguished, and the attribute of the distinguished moving body is specified. Further, the specified attribute information of the moving body, the signage ID information of the digital signage 50A which executed the photographing operation, the information of the date on which the photographing operation was performed, and the information of the time at which the photographing operation was performed are stored in the moving body attribute information DB 406.

### (Pattern 4P06)

The process of Step S4103 is executed, and it is judged whether or not a desired amount of data is accumulated in the moving body attribute information DB 406.

### (Pattern 4P07)

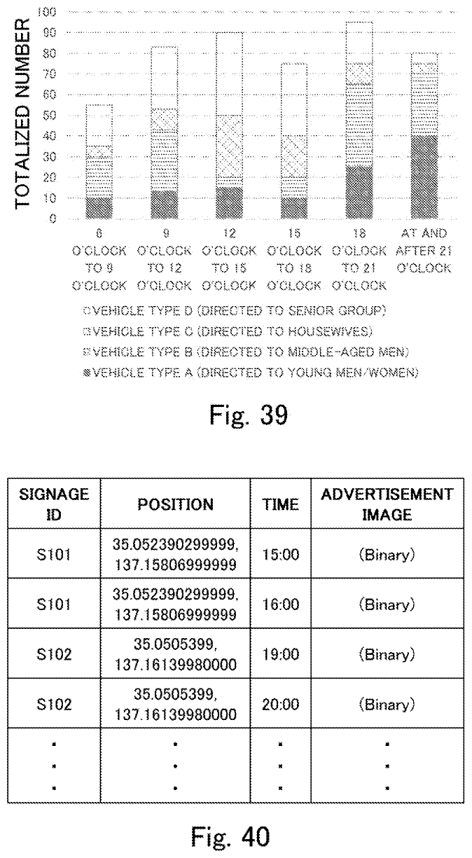

The process of Step S4104 is executed. If it is judged that the desired amount of data is accumulated in the moving body attribute information DB 406, the data stored in the moving body attribute information DB 406 is extracted. Then, the attribute of the extracted data is subjected to the statistical processing. Further, in this embodiment, in an example of the statistical processing for the attribute, the attribute of the data is subjected to the statistical processing for every time zone. FIG. 39 shows an exemplary graph to depict a result in which the attribute is subjected to the statistical processing for every time zone. The example shown in FIG. 39 is illustrative of such an exemplary case that the statistics are taken for the vehicle type as the attribute of the moving body. Without being limited to the example shown in FIG. 39, the statistical processing unit 408 can take statistics for various attributes including, for example, the type of the moving body and the age group if the moving body is the person, in relation to every time zone of the photographing operation. Further, it is not necessarily indispensable for the moving body attribute specifying unit 405 to take statistics for every time zone of the photographing operation. The moving body attribute specifying unit 405 nay perform the statistical processing for the data stored in the moving body attribute information DB 406 for every date.

### (Pattern 4P08)

The process of Step S4105 is executed, and the delivery management server 40A requests the data center 30 to transmit the information relevant to the advertisement stored in the advertisement information DB 306.

### (Pattern 4P09)

The process of Step S3301 is executed, and the data center 30 receivers the request signal for requesting the transmission of the information relevant to the advertisement stored in the advertisement information DB 306 from the delivery management server 40A.

### (Pattern 4P10)

The process of Step S3302 is executed, and the information stored in the advertisement information DB 306 is extracted.

### (Pattern 4P11)

The process of Step S3303 is executed, and the data center 30 transmits the information relevant to the advertisement extracted from the advertisement information DB 306 to the delivery management server 40A.

### (Pattern 4P12)

The process of Step S4106 is executed, and the delivery management server 40A receives the information relevant to the advertisement stored is advertisement information DB 306 from the data center 30. In this procedure, the delivery advertisement determining unit 409 determines the optimum advertisement information to be delivered to the digital signage 50A on the basis of the result of the statistical processing exemplified in FIG. 39 and the received information relevant to the advertisement. For example, according to the result of the statistical processing exemplified in FIG. 39, many vehicles directed to the senior group pass in front of the digital signage 50A in the time zone in the daytime. Further, many vehicles directed to young men/women pass in front of the digital signage 50A in the time zone in the night. Accordingly, the delivery management server 40A may determine that the advertisement image directed to the higher age group as the target is displayed many times in the time zone in the daytime, and the advertisement image directed to the lower age group as the target is displayed many times in the time zone in the night, according to the information relevant to the advertisement received from the data center 30.

### (Pattern 4P13)

The process of Step S4107 is executed, and the delivery management server 40A delivers the advertisement image information determined to be delivered and the display time information of the advertisement image to the digital signage 50A. Further, the delivery management server 40A may store the delivery destination signage ID information, the delivery advertisement image information, and the advertisement display time information. That is, the delivery management server 40A can manage what advertisement image is displayed at what time on what digital signage 50A, according to the delivery destination signage ID information, the delivery advertisement image information, and the advertisement display time information. Further, the delivery management server 40A may acquire the information in relation to the positions at which the respective signages are installed, from the data center 30, the information being stored in the signage information DB 305. That is, the digital signage 50A can manage what advertisement image is displayed at what place at what time. In this case, the information about what advertisement image is displayed at what place at what time is an example of the “display position information if the advertisement is displayed” of the present disclosure. FIG. 40 shows exemplary display position information if the advertisement is displayed.

### (Pattern 4P14)

The process of Step S5201 is executed, and the digital signage 50A receives the advertisement image information and the display time information of the advertisement image from the delivery management server 40A.

### (Pattern 4P15)

The process of Step S5202 is executed, and the digital signage 50A displays the received advertisement image in accordance with the display time information. That is, for example, the digital signage 50A displays the advertisement image directed to the higher age group as the target many times in the time zone in the daytime, and the digital signage 50A displays the advertisement image directed to the lower age group as the target many times in the time zone in the night.

### (Effect of Second Embodiment)

In the case of the advertisement display system 2 as described above, the attribute information of the moving body passing in front of the digital signage 50A is accumulated. Then, the advertisement display system 2 takes statistics for the vehicle type as an example of the attribute information in relation to every time zone. Then, if a tendency of the attribute distribution is found as a result the statistical processing such that the vehicle of the type directed to the senior group passes in front of the digital signage 50A many times in the time zone in the daytime, and the vehicle of the type directed to the young men/women passes in front of the digital signage 50A many times in the time zone in the night, then the advertisement directed to the target of the senior group is displayed on the digital signage 50A any times in the time zone in the daytime, and the advertisement directed to the target of the young men/women is displayed on the digital signage 50A many times in the time zone in the night. That is, the advertisement display system 2 described above makes it possible to enhance the power of the advertisement displayed on the digital signage 50A to appeal to customers.

Further, the delivery management server 40A manages the display position information which indicates what advertisement is displayed at what place at what time. Therefore, for example, if different advertisements are displayed in the same time zone on the digital signages 50A which are separated by short distances, as a result of the statistical processing for the attribute, the delivery management server 40 can change the advertisements displayed on the digital signages 50A which are separated by short distances so that the same advertisement is displayed on all of the digital signages 50A. That is, the delivery management server 40A makes it possible to enhance the effect of the advertisement by utilizing the display position information.

### (Modified Embodiment of Second Embodiment)

In the advertisement display system 2 described above, the optimum advertisement information to be delivered to the digital signage 50A is determined in Pattern 4P12 on the basis of the result of the statistical processing performed by the statistical processing unit 408 and the information relevant to the advertisement stored in the advertisement information DB 306. However, the optimum advertisement information to be delivered to the digital signage 50A may be determined by further utilizing another information stored in the data center 30. For example, the delivery management server 40A acquires the information stored in the photographed advertisement information DB 303 and the vehicle information DB 304 from the data center 30. In this case, for example, it is found that a young man is interested in an advertisement of a suit and he has photographed the image, on the basis of the information stored in the photographed advertisement information DB 303 and the vehicle information DB 304. Therefore, the delivery advertisement determining unit 409 may determine that the advertisement of the suit included in the advertisements directed to young men/women is preferentially displayed, in addition to the determination that the advertisements directed to young men/women are displayed in the time zone in the night. Even in the case of the advertisement display system 2 as described above, it is possible to enhance the power of the advertisement displayed on the digital signage 50A to appeal to customers.

Further, the delivery management server 40A may acquire the information stored in the signage information DB 305 from the data center 30. Then, the position of the digital signage 50, at which the young man is interested in the advertisement of the suit and the digital signage 50 has displayed the photographed advertisement, may be specified from the position information stored in the photographed advertisement information DB 303 and the position information stored in the signage information DB 305. Then, it may be determined that the advertisement of the suit is preferentially displayed on the digital signage 50A which is disposed near to the specified digital signage 50. Even in the case of the advertisement display system 2 as described above, it is possible to enhance the power of the advertisement displayed on the digital signage 50A to appeal to customers.

### Other Embodiments

The embodiments described above are exemplified by way of example in every sense. The present disclosure may be carried out while appropriately making changes within a range without deviating from the gist or essential characteristics thereof.

Further, the configuration and the processes explained in this disclosure can be carried out while freely combining them unless any technical contradiction or inconsistency arises.

Further, the process, which has been explained as being performed by one apparatus or device, may be executed by a plurality of apparatuses or devices in a shared manner. Alternatively, the process, which has been explained as being performed by the different apparatuses or devices, may be executed by one apparatus or device without causing any problem. In the computer system, it is possible to flexibly change the way of realization of the respective functions by means of any hardware configuration (server configuration).

The present disclosure can be also realized such that a computer program, in which the functions explained in the foregoing embodiments are packaged, is supplied to a computer, and the program is read and executed by one or more processors possessed by the computer. The computer program as described above may be provided for the computer by means of any non-transitory computer-readable storage medium capable of being connected to a system bus of the computer, or the computer program may be provided for the computer by the aid of a network. The non-transitory computer-readable storage medium includes, for example, disks of arbitrary types such as magnetic disk (floppy (registered trademark) disk, hard disk drive (HDD) and the like), optical disk (CD-ROM, DVD disk, Blu-ray Disc and the like) and the like, read only memory (ROM), random access memory (RAM), EPROM, EEPROM, magnetic card, flash memory, optical card, and media of arbitrary types suitable for storing electronic commands.

What is claimed is:

1. An information processing apparatus comprising a controller configured to execute:
displaying an advertisement;
specifying a moving body that moves at a place at which the advertisement to be displayed can be viewed;
storing attribute information of the specified moving body;
performing statistical processing for the stored attribute information of the moving body; and
determining the advertisement to be displayed on the basis of a result of the statistical processing.

2. The information processing apparatus according to claim 1, wherein the controller configured to further execute:
storing a time at which the specified moving body has moved at the place at which the advertisement to be displayed can be viewed; and
performing statistical processing for the stored attribute information of the moving body in relation to every time zone.

3. The information processing apparatus according to claim 1, wherein:
the specified moving body is a person; and
the stored attribute information of the moving body is information relevant to an appearance of the person.

4. The information processing apparatus according to claim 1, wherein:
the specified moving body is a vehicle; and
the stored attribute information of the moving is information relevant to a type of the vehicle.

5. The information processing apparatus according to claim 1, wherein the controller configured to further execute:
further storing display position information if the advertisement is displayed.

6. The information processing apparatus according to claim 1, wherein the controller configured to further execute:
acquiring information relevant to a photographed advertisement, attribute information of a viewer, and traveling history information of a vehicle from a database which stores the information relevant to the photographed advertisement as photographed if it is distinguished that a gesture performed by the viewer who has viewed the advertisement in a traveling vehicle is a predetermined gesture or if it is distinguished that a voice uttered by the viewer has a predetermined voice pattern, the attribute information of the viewer, and the traveling history information of the vehicle; and
determining the advertisement to be displayed further on the basis of the acquired information relevant to the advertisement, the attribute information of the viewer, and the traveling history information of the vehicle.

7. An information processing apparatus comprising a controller configured to execute:
distinguishing a gesture performed by a viewer who has viewed the advertisement in a traveling vehicle as a predetermined gesture or distinguishing a voice uttered by the viewer as having a predetermined voice pattern;
photographing a scene including the advertisement viewed by the viewer if it is distinguished that the gesture performed by the viewer is the predetermined gesture or if it is distinguished that the voice uttered by the viewer has the predetermined voice pattern; and
storing image information of an image in which the photographed scene including the advertisement is imaged and the traveling history information of the vehicle.

8. An information processing method comprising:
displaying an advertisement;
specifying a moving body that moves at a place at which the advertisement to be displayed can be viewed;
storing attribute information of the specified moving body;
performing statistical processing for the stored attribute information of the moving body; and
determining the advertisement to be displayed on the basis of a result of the statistical processing.

9. A non-transitory storage medium storing a program for allowing a computer to execute:
displaying an advertisement;
specifying a moving body that moves at a place at which the advertisement to be displayed can be viewed;
storing attribute information of the specified moving body;
performing statistical processing for the stored attribute information of the moving body; and
determining the advertisement to be displayed on the basis of a result of the statistical processing.
